(19) United States
(12) Patent Application Publication
(10) Pub. No.: US 2007/0245239 A1
(43) Pub. Date: Oct. 18, 2007

(54) PERCEPTION RESEARCH SYSTEM AND METHOD

(75) Inventor: Linda Jeo Zerba, Portland, OR (US)

Correspondence Address: DAVIS WRIGHT TREMAINE, LLP, 1201 Third Avenue, Suite 2200, SEATTLE, WA, 98101-3045, US

(73) Assignee: BIG SQUIRREL, LLC DBA DEPUTY CONSULTING, Portland, OR (US)

(21) Appl. No.: 11/690,772

(22) Filed: Mar. 23, 2007

Related U.S. Application Data
(60) Provisional application No. 60/785,056, filed on Mar. 23, 2006.

(51) Int. Cl. G07G 1/00

(52) U.S. Cl. 715/705; 705/10

(57) ABSTRACT

A perception research system and method is configured to combine aspects of both quantitative research and qualitative research. The perception research system includes a user interface that allows users to interact with the system based in part on the graphical nature of the user interface to form qualitative associations between various concepts expressed through image cards, text cards, ranking inputs, and group icons. The system allows for record capture of statistics associated with the qualitative associations expressed by users through their interaction with the system to allow for later quantitative analysis of the expressed qualitative associations. By combining the quantitative and qualitative research worlds, the system offers a way to develop, test, and validate understanding of perceptions of humans such as involving consumer perceptions of new products, branding strategies, and other creative concepts using ethnographic and other methodologies combined with statistical expression of such.

### CROSS REFERENCE TO RELATED APPLICATION

This application claims priority benefit of provisional application Ser. No. 60/785,056 filed Mar. 23, 2006, the content of which is incorporated in its entirety.

### BACKGROUND OF THE INVENTION

1. Field of the Invention

The present invention is directed generally to perception research.

2. Description of the Related Art

Research regarding perceptions and opinions of humans, such as with consumer research, has traditionally been divided into quantitative research and qualitative research. With quantitative research, data is intended to provide statistical validity to past actions as a way to predict future behavior. On the other hand, the focus of qualitative research is to develop strategic thinking and emotional connectivity with a target audience.

### BRIEF DESCRIPTION OF THE SEVERAL VIEWS OF THE DRAWING(S)

FIG. 1 is a schematic block diagram of a computer and associated equipment that is used with implementations of the system.

FIG. 2 is a schematic block diagram of elements of the system.

FIG. 3 is a schematic of a version of a user interface involved with the system.

FIG. 4 is a schematic of representative examples of image cards involved with the system.

FIG. 5 is a schematic of representative examples of text cards involved with the system.

FIG. 6 is a schematic of a version of a user interface involved with the system.

FIG. 7 is a flowchart of a version of a method involved with the system.

FIG. 8 is a schematic of a version of a user interface involved with the system.

FIG. 9 is a schematic of a version of a user interface involved with the system.

FIG. 10 is a flowchart of a version of a method involved with the system.

FIG. 11 is a schematic of a version of a user interface involved with the system.

FIG. 12 is a flowchart of a version of a method involved with the system.

FIG. 13 is a schematic of a version of a user interface involved with the system.

FIG. 14 is a flowchart of a version of a method involved with the system.

FIG. 15 is a schematic of a version of a user interface involved with the system.

FIG. 16 is a flowchart of a version of a method involved with the system.

FIG. 17 is a schematic of a version of a user interface involved with the system.

FIG. 18 is a flowchart of a version of a method involved with the system.

FIG. 19 is a schematic of a version of a user interface involved with the system.

FIG. 20 is a schematic of a version of a user interface involved with the system.

FIG. 21 is a schematic of a version of a user interface involved with the system.

FIG. 22 is a schematic of a version of a user interface involved with the system.

FIG. 23 is a schematic of a version of a user interface involved with the system.

FIG. 24 is a schematic of a version of a user interface involved with the system.

FIG. 25 is a schematic of a version of a user interface involved with the system.

FIG. 26 is a schematic of a version of a user interface involved with the system.

FIG. 27 is a schematic of a version of a user interface involved with the system.

FIG. 28 is a schematic of a version of a user interface involved with the system.

FIG. 29 is a schematic of a version of a user interface involved with the system.

FIG. 30 is a schematic of a version of a user interface involved with the system.

FIG. 31 is a schematic of a version of a user interface involved with the system.

FIG. 32 is a schematic of a version of a user interface involved with the system.

### DETAILED DESCRIPTION OF THE INVENTION

As will be discussed in greater detail herein, a perception research system and method is configured to combine aspects of both quantitative research and qualitative research. The perception research system includes a user interface that allows users to interact with the system based in part on the graphical nature of the user interface to form qualitative associations between various concepts expressed through image cards, text cards, ranking inputs, and group icons.

The system allows for record capture of statistics associated with the qualitative associations expressed by users through their interaction with the system to allow for later quantitative analysis of the expressed qualitative associations. Consequently, quantitative analysis is allowed use in the world of qualitative research through the system. By combining the quantitative and qualitative research worlds, the system offers a way to develop, test, and validate understanding of perceptions of humans such as involving consumer perceptions of new products, branding strategies, and other creative concepts using ethnographic and other methodologies combined with statistical expression of such.

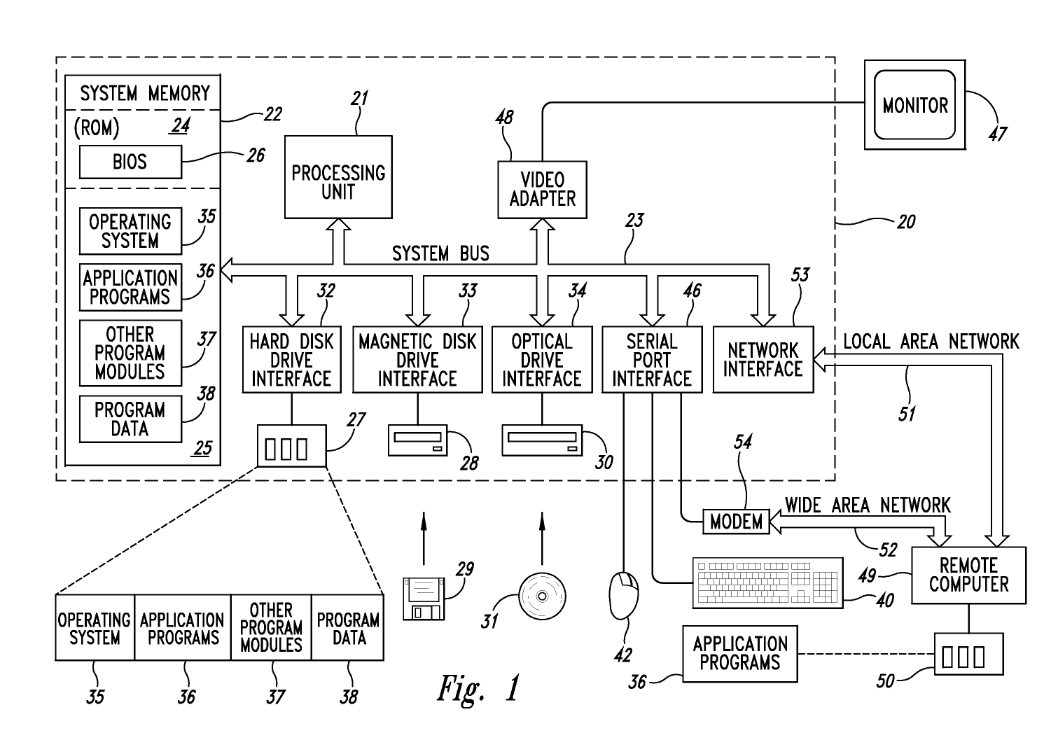

FIG. 1 is a diagram of the hardware and operating environment in conjunction with which implementations may be practiced. The description of FIG. 1 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with implementations that may be practiced has been described. The computer in conjunction with implementation that may be practiced may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

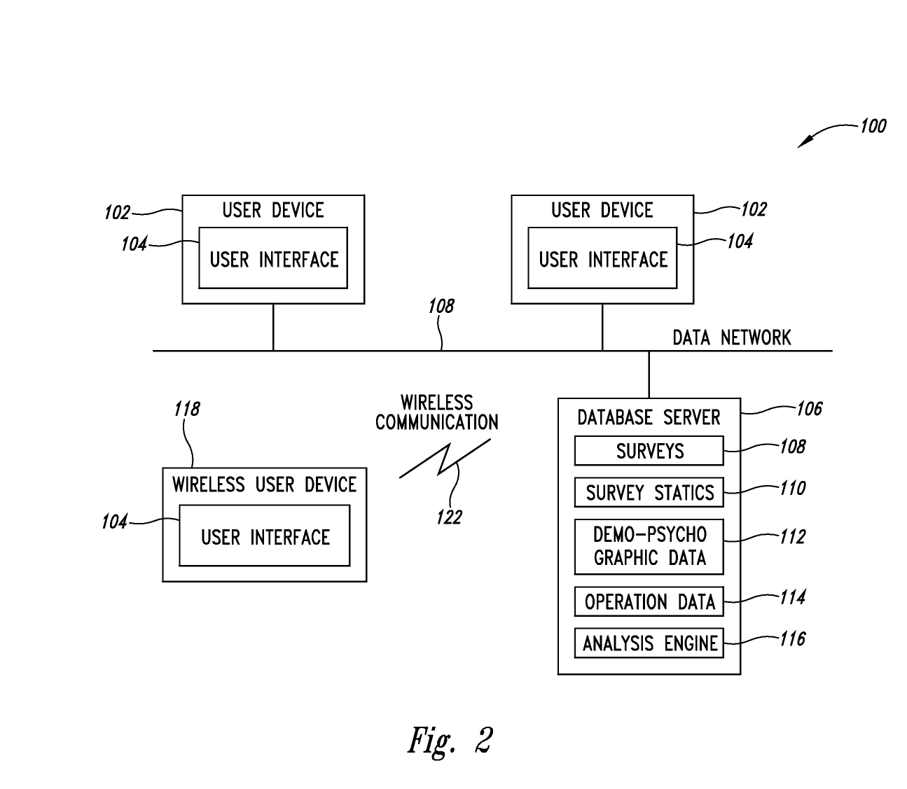

As shown in FIG. 2, a depicted system implementation 100 of a perception research system includes user devices 102 each having a user interface 104 in communication with a database server 106 through a data network 108. The database server 106 includes a collection of one or more surveys 108, each containing a set of instructions to be displayed on the user interface 104 in conjunction with data collection related to perceptions of users of the system.

The server 106 further includes storage 110 for general survey statistics, storage 112 for demographic and psychographic data collected from users of the system during use of the system or at another time, storage 114 of operation data collected through aspects of the system described herein, and an analysis engine 116 used to generate various statistical reports based upon the data contained therein.

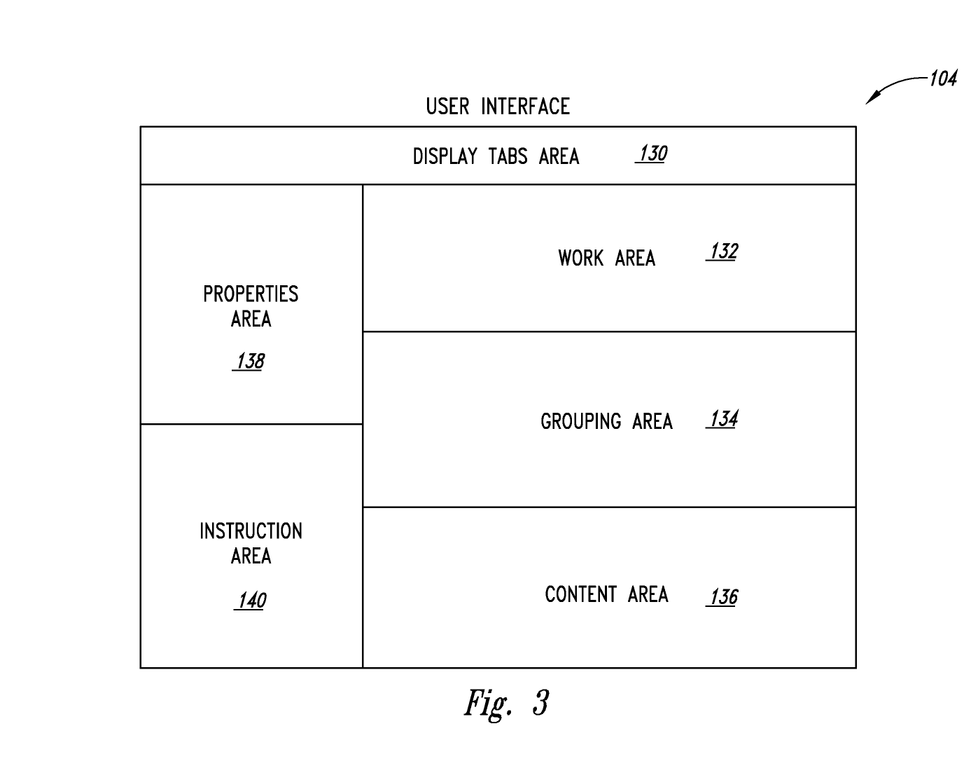

The depicted implementation 100 further includes a wireless user device 118 with another form of the user interface 104 for users to access the database server 106 through wireless communication 122 rather than through the data network 108. A depicted implementation of the user interface 104 is shown in FIG. 3 to include a display tabs area 130, a work area 132, a grouping area 134, a content area 136, a properties area 138, and an instruction area 140. Other implementations of the user interface 104 are portioned with other numbers of areas to accomplish various operation described below.

Some of the implementations of the user interface 104 have fewer areas than that depicted so that some of the depicted areas are combined or substituted in another manner. Other implementations of the user interface 104 have more areas than depicted such as having one or more of the depicted areas divided or having other areas in addition to those depicted. These other implementations of the user interface 104 although possibly having different appearances will still allow for collection of one or more of perception data through one or more of the various operations so described herein.

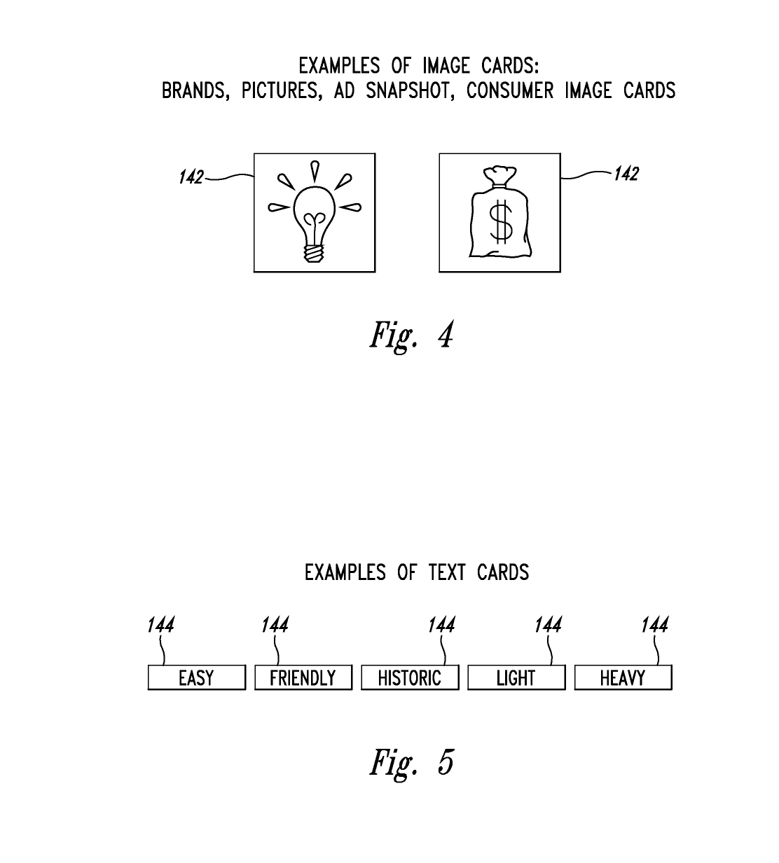

As further explained, image and/or text cards, collectively known as cards, used in conjunction with the user interface 104 provide mechanisms for users to express their perceptions while allowing the system to collect statistical data based upon such expressed perceptions. Examples of image cards 142 are shown in FIG. 4 as exemplary representations, not to be construed as limiting. Examples of text cards 144 are shown in FIG. 5 as exemplary representations, not to be construed as limiting.

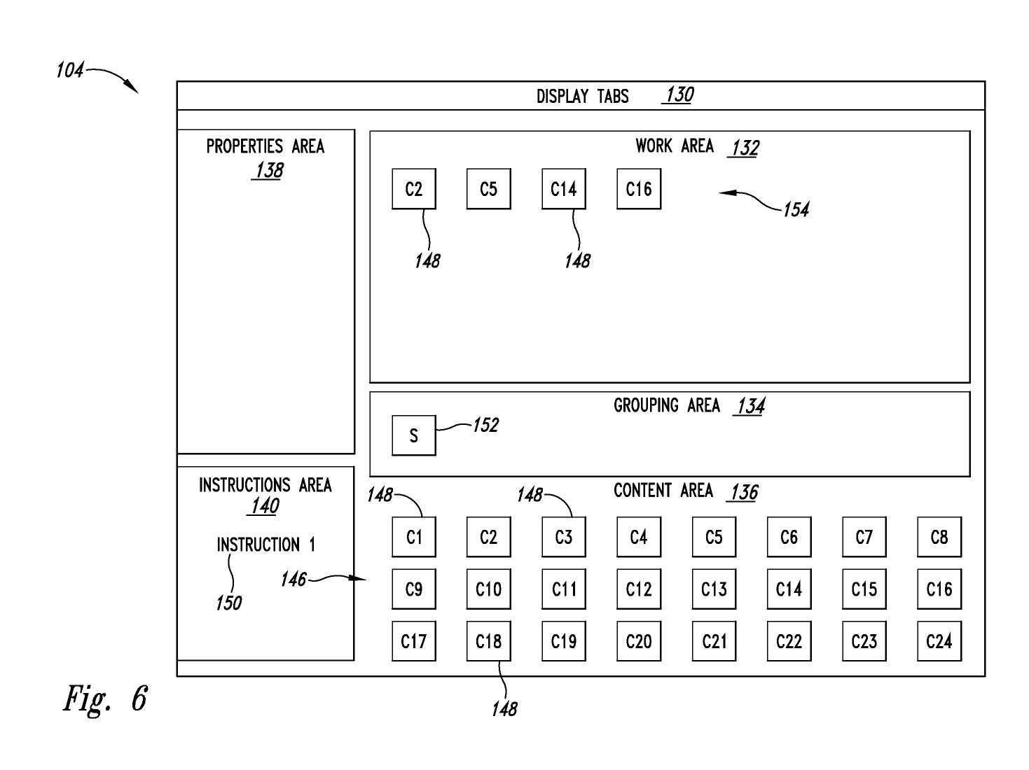

The user interface 104 is shown in FIG. 6 as being used to perform a selection operation to select from a collection 146 of cards 148 being displayed in the content area 136 in response to an instruction #1 150 as contained in the storage 108 being displayed in the instruction area 140. A selection icon 152 is shown to be displayed in the grouping area 134 and represents a selected portion 154 being displayed in the work area 132 of the collection 146 of the cards 148. As selected, each of the cards 148 of the selected portion 154 has associated statistical information stored in the storage 114 for operation data, which includes the instruction #1 150 being related to each of the cards selected in the selected portion.

Selection of the cards 148 from the collection 146 can be accomplished through various forms of assistance through user input such as through hand operated input devices such as keyboards, mice, trackballs and the like, or eye operated device such as retina scanning devices, voice input device such as through microphone controlled input, feet operated devices such as through foot pedals linked to the user interface 104, or through other devices for user input.

One approach is to select one of the cards 148 from the collection by dragging the selected of the cards from the content area 136 to the work area 132. Another approach is to designate through mouse/trackball clicks, or through other approaches such as voice announcement a particular designation for the one of the cards of desire for selection. Other methods using input devices to designate desired ones of the cards 148 to be demarcated for selection are also included within the scope of the system. As one of the cards 148 is selected, information relevant to the card can be displayed in the properties area 138. Included with such information can be an enlargement of the card for better visual inspection of the card by a user of the system.

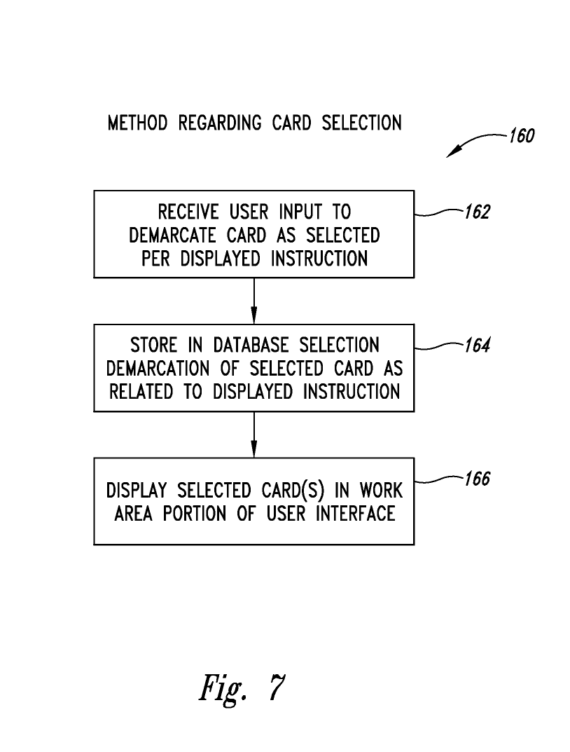

A method 160 regarding card selection is shown in FIG. 7 to include receiving (step 162) user input to demarcate one or more of the cards 148 as selected based upon user input in response to an instruction displayed in the instruction area 140. Identification of the selected one or more of the demarcated cards 148 as related to the displayed instruction is stored (step 164) in the storage 114 for operation data of the database 126. The user interface 104 displays the selected one or more of the cards 148 in the work area 132 of the user interface (step 160).

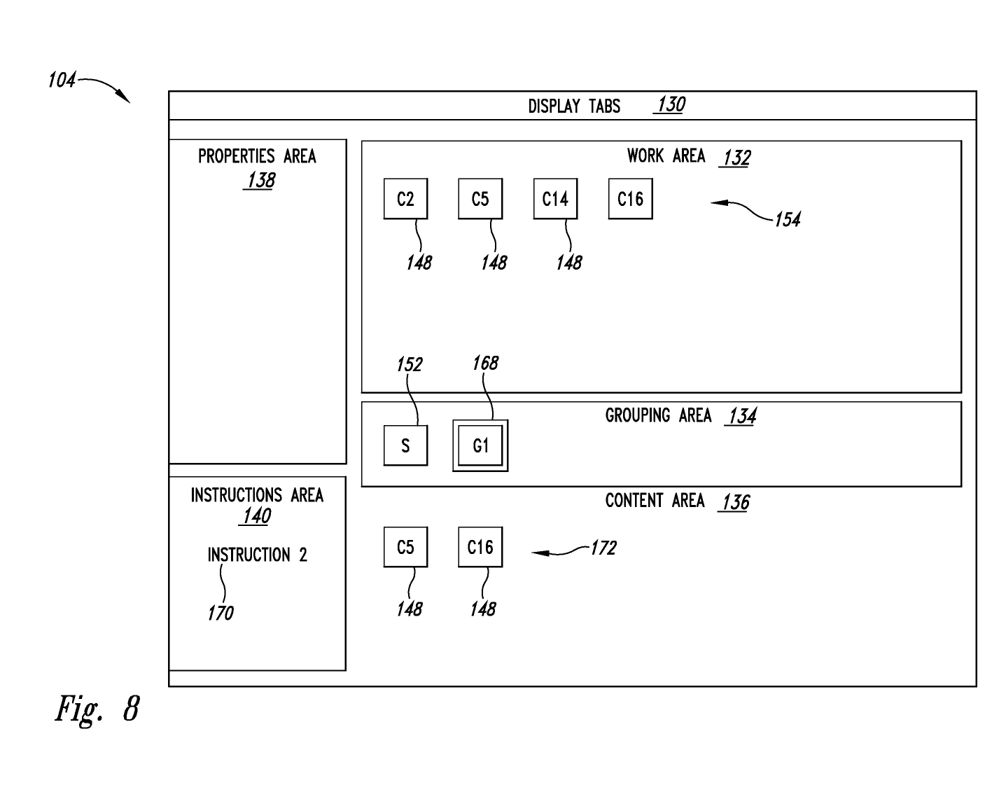

The user interface 104 is shown in FIG. 8 as being used to perform a grouping operation to associate one or more of the cards 148 from the selected portion 154 with a group icon 168, shown in FIG. 8 as G1, according to instruction #2 170 displayed in the instruction area 140. A grouped portion 172 of the cards 148 from the selected portion 154 of cards 148 is displayed in the content area 136 when the group icon 168 is active, as indicated with a double-line border as depicted. As grouped, each of the cards 148 of the grouped portion 172 has associated statistical information stored in the storage 114 for operation data, which includes the instruction #2 170 being related to each of the cards that are part of the grouped portion.

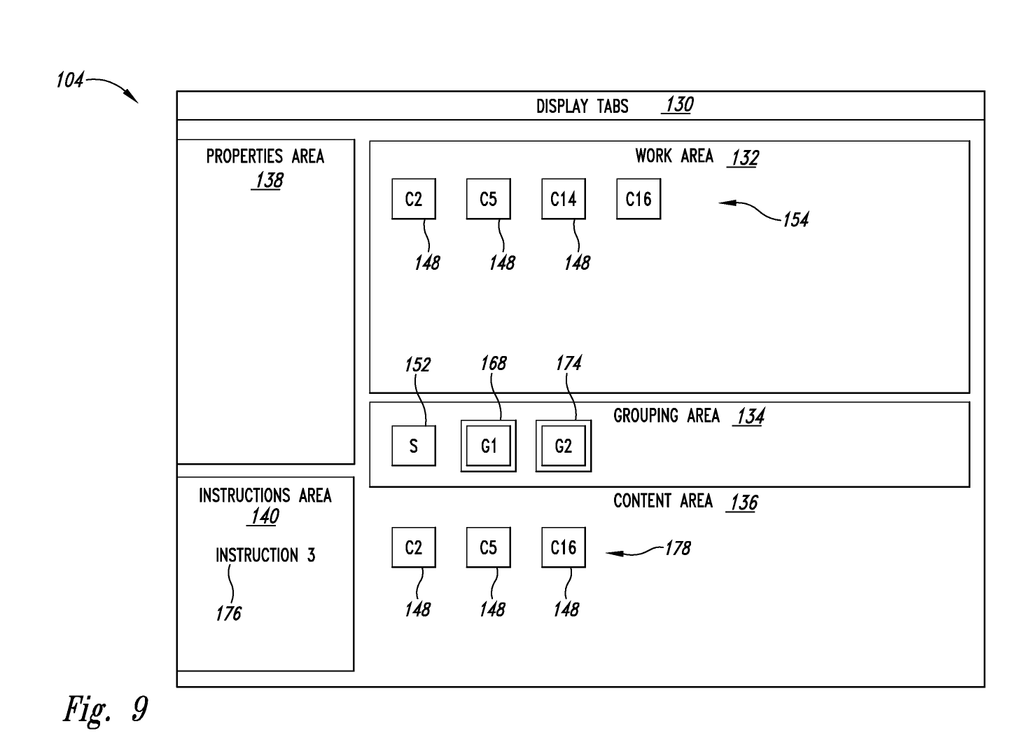

The user interface 104 is shown in FIG. 9 as being used to perform a grouping operation to associate one or more of the cards 148 from the selected portion 154 with a group icon 174, shown in FIG. 9 as G2, according to instruction #3 176 displayed in the instruction area 140. A grouped portion 178 of the cards 148 from the selected portion 154 of cards 148 is displayed in the content area 136 when the group icon 174 is active, as indicated with a double-line border as depicted. As grouped, each of the cards 148 of the grouped portion 178 has associated statistical information stored in the storage 114 for operation data, which includes the instruction #3 176 being related to each of the cards that are part of the grouped portion.

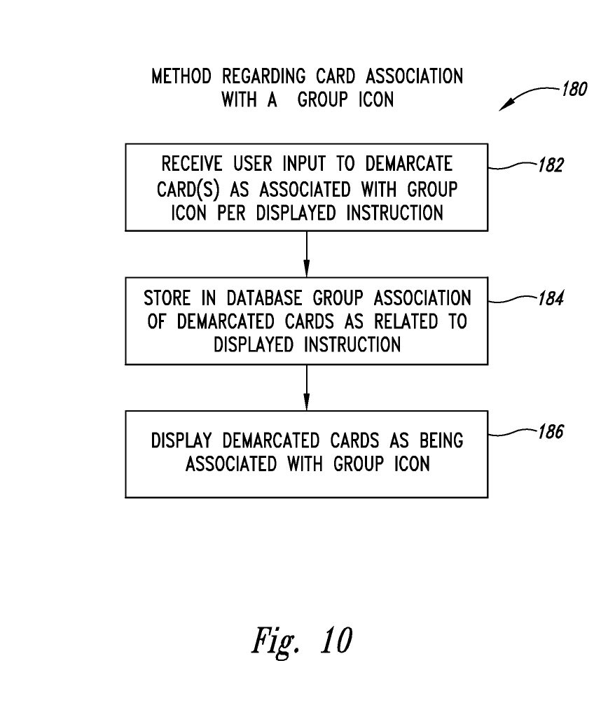

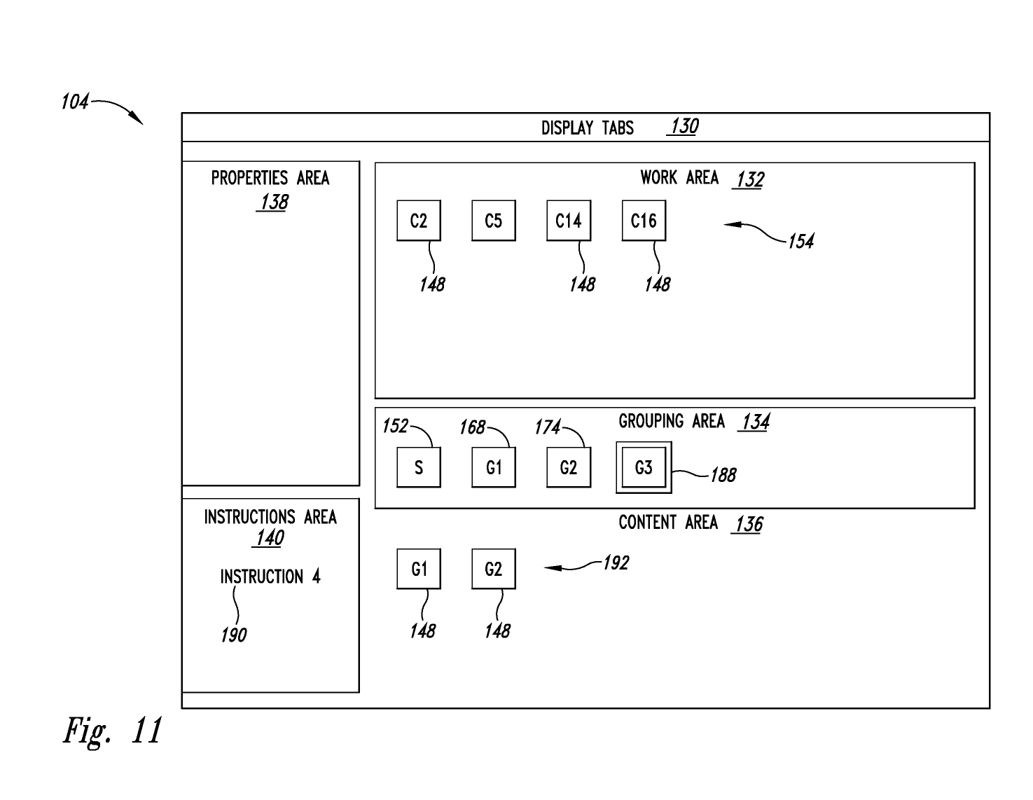

A method 180 regarding card association with a group icon is shown in FIG. 10 to include receiving (step 182) user input to demarcate one or more of the cards 148 as being associated with a group icon based upon user input in response to an instruction displayed in the instruction area 140. Identification of the associated one or more of the cards 148 along with identification of the group icon that they are assigned thereto as related to the displayed instruction is stored (step 184) in the storage 114 for operation data of the database 126. The user interface 104 displays the one or more of the cards 148 as associated to the group icon (step 186).

The user interface 104 is shown in FIG. 11 as being used to perform a second type of grouping operation to associate the group icon 168, G1 is depicted, and the group icon 174, G2 is depicted, with a group icon 188, shown in FIG. 11 as G3, according to instruction #4 190 displayed in the instruction area 140. A grouped portion 192 of the group icon 168 and the group icon 174 is displayed in the content area 136 when the group icon 188 is active, as indicated with a double-line border as depicted. As grouped, each of the group icon 174 and the group icon 188 has associated statistical information stored in the storage 114 for operation data, which includes the instruction #4 190 being related to each of the group icon 168 and the group icon 174 that are part of the grouped portion 192.

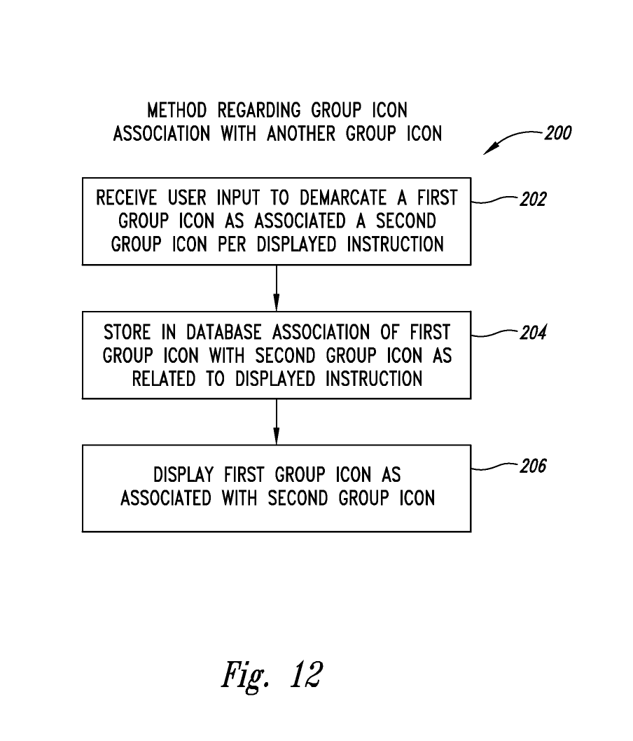

A method 200 regarding group icon association with another group icon is shown in FIG. 12 to include receiving (step 202) user input to demarcate a first group icon as being associated with a second group icon per an instruction displayed in the instruction area 140. Identification of the first group icon as associated with second group icon as related to the displayed instruction is stored (step 204) in the storage 114 for operation data of the database 106. The user interface 104 displays the first group icon as associated with the second group icon (step 206). The method 180 and the method 200 can also be combined so that one or more of the cards 148 and one or more group icons can be associated with another group icon, which sometimes is referred to as a pile.

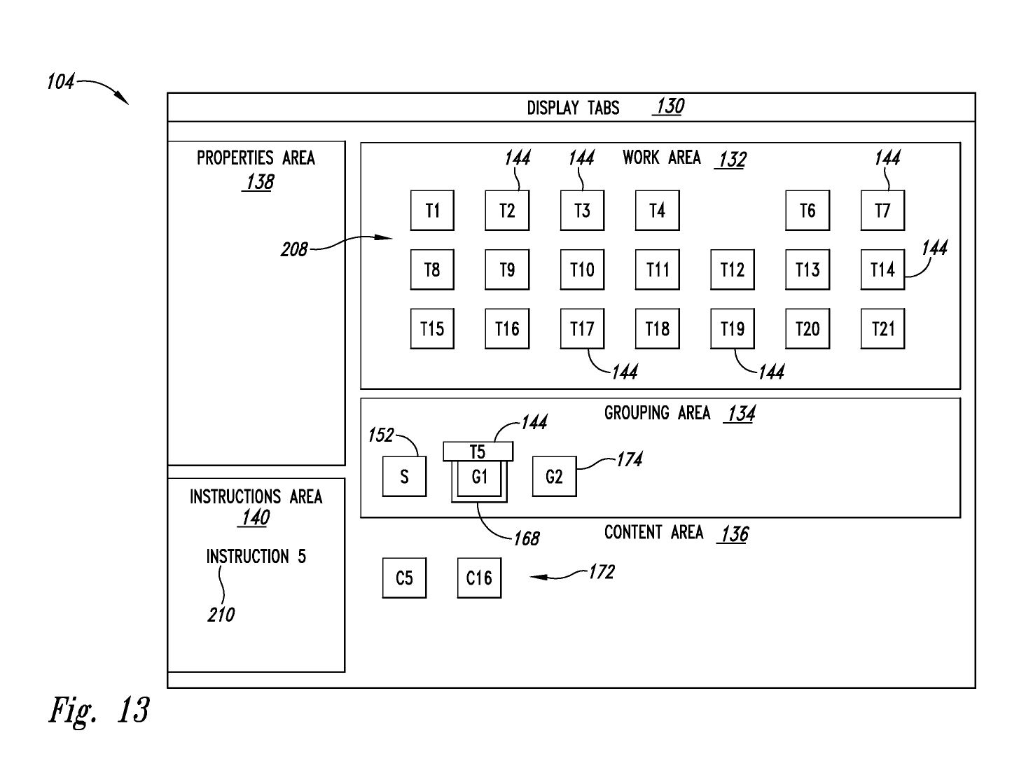

The user interface 104 is shown in FIG. 13 as being used to perform assignment to the group icon 168 of one of the text cards 144, depicted as T5 in FIG. 13, from a collection 208 of the text cards being displayed in the work area 132 according to instruction #5 210 displayed in the instruction area 140. As assigned, the text card 144, depicted as T5, has associated statistical information stored in the storage 114 for operation data, which includes the instruction #5 210 being related to group icon 168 and the text card, depicted as T5, assigned thereto. An assigned text card 144 can contain a title and/or some property designation for the group icon of the text card.

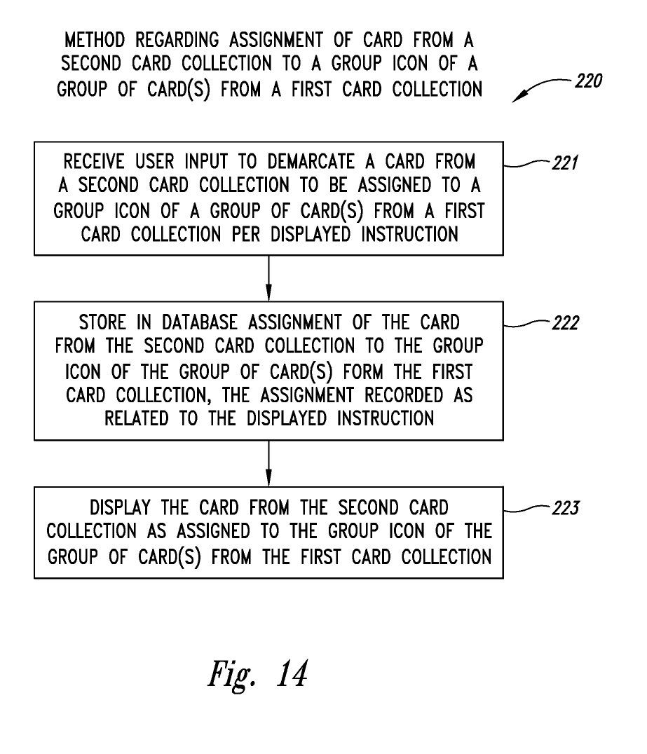

A method 220 regarding card assignment of one of the cards 148 from a second card collection to a group icon of a group of the cards from a first card collection is shown in FIG. 14 to include receiving (step 221) user input to demarcate a card from a second card collection to be assigned to a group icon of a group of cards from a first card collection based upon user input in response to an instruction displayed in the instruction area 140. Identification of the card 148 from the second card collection and identification of the group icon that the card is assigned thereto as related to the displayed instruction is stored (step 222) in the storage 114 for operation data of the database 106. The user interface 104 displays the card 148 as assigned to the group icon (step 223).

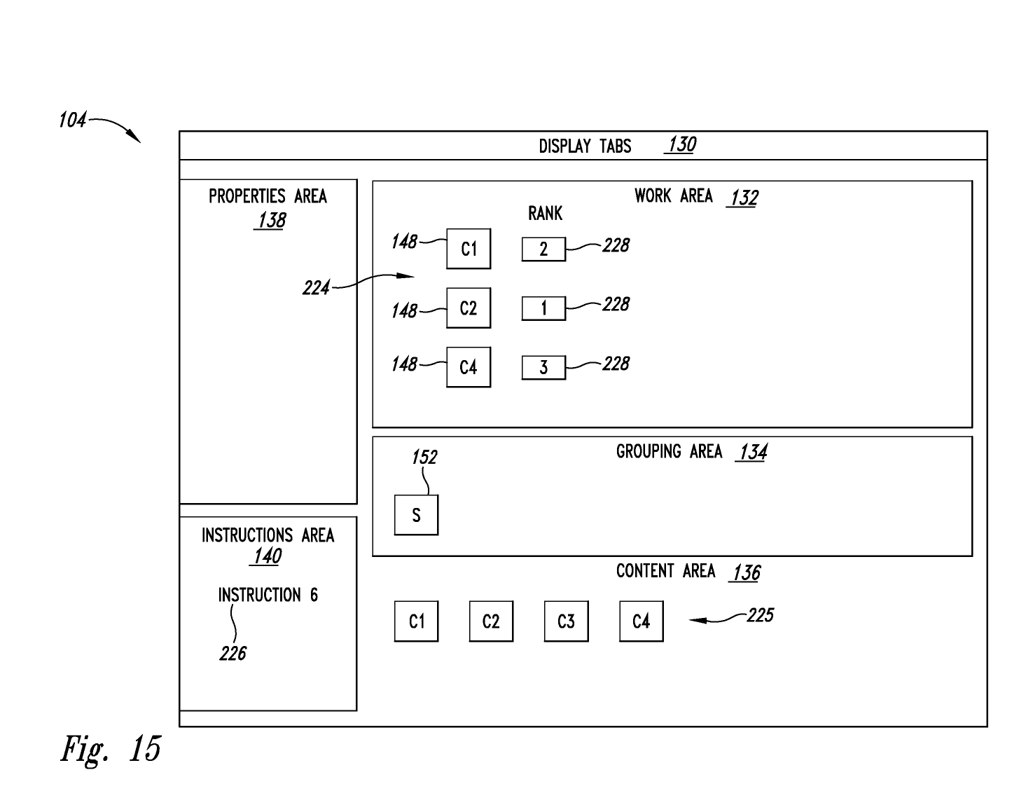

The user interface 104 is shown in FIG. 15 as being used to perform a ranking of a selection 224 of a collection 225 of the cards 148 according to instruction #6 226 displayed in the instruction area 140. The ranking of the selection 224 includes input fields 228 displayed as adjacent each of the cards 148 of the selection. Each of the input fields 226 is used to display a number entered through an input device by a user of the system. As depicted, each of the numbers being displayed in a different one of the input fields 226 indicates the rank order of each of the cards 148 associated with its adjacent input field. As ranked, each of the cards 148 of the selection 224 has associated statistical information stored in the storage 114 for operation data, which includes the instruction #6 224 being related to the card and the ranking number associated therewith.

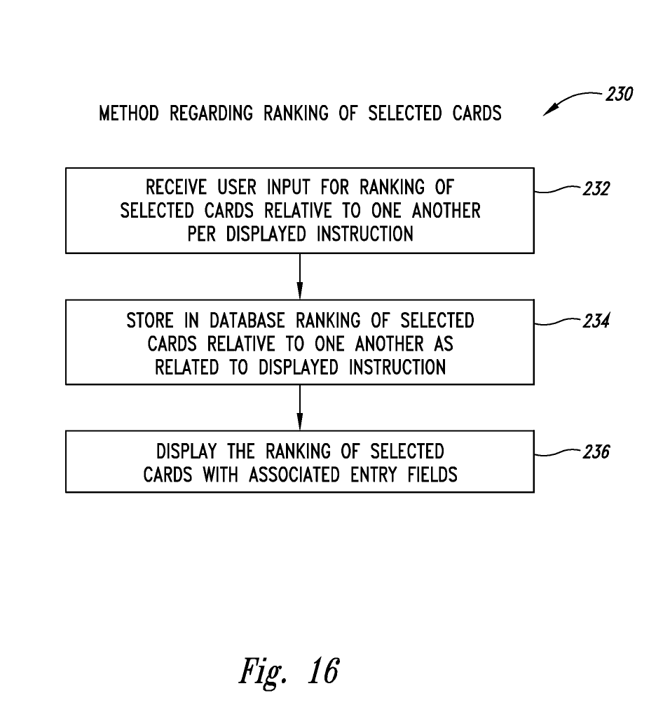

A method 230 regarding ranking of selected cards 148 is shown in FIG. 16 to include receiving (step 232) user input for ranking of selected cards relative to one another based upon user input in response to an instruction displayed in the instruction area 140. Identification of the ranked cards 148 along with their ranking as related to the displayed instruction is stored (step 234) in the storage 114 for operation data of the database 106. The user interface 104 displays the ranked cards 148 along with the rankings as contained in associated entry fields 228 (step 236).

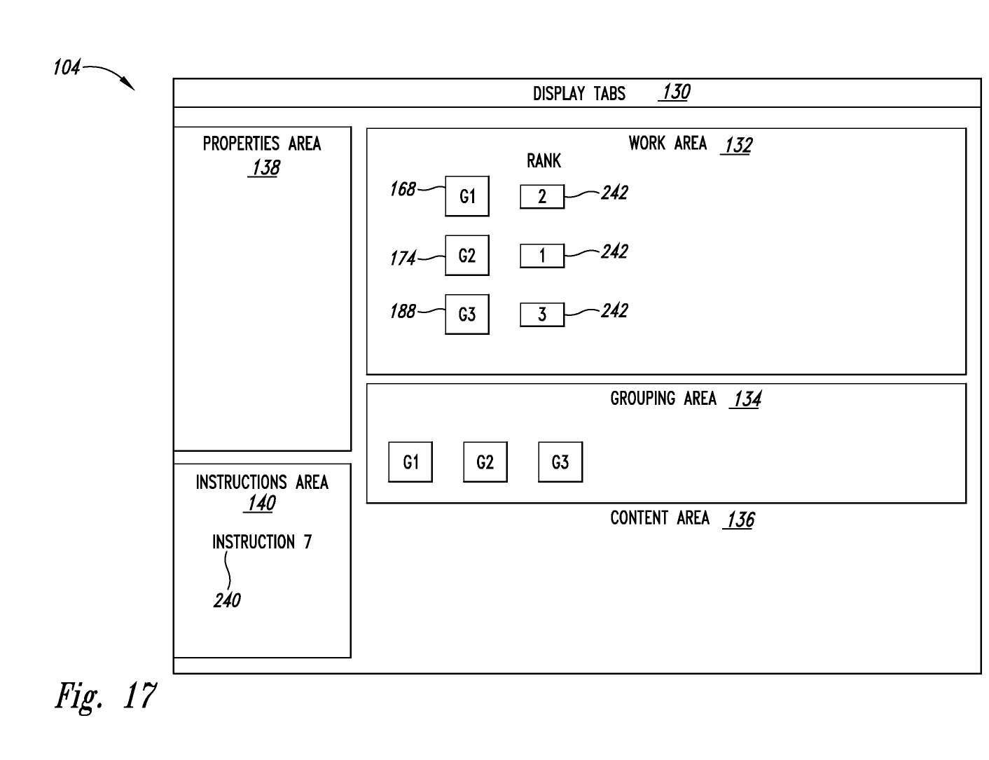

The user interface 104 is shown in FIG. 17 as being used to perform a ranking of the group icon 168, the group icon 174, and the group icon 188 according to instruction #7 240 displayed in the instruction area 140. The ranking includes input fields 242 displayed as adjacent each of the group icon 168, the group icon 174, and the group icon 188. Each of the input fields 242 is used to display a number entered through an input device by a user of the system. As depicted, each of the numbers being displayed in a different one of the input fields 242 indicates the rank order of each of the group icon 168, the group icon 174, and the group icon 188 associated with its adjacent input field. As ranked, each of the group icon 168, the group icon 174, and the group icon 188 has associated statistical information stored in the storage 114 for operation data, which includes the instruction #7 240 being related to the group icon and the ranking number associated therewith.

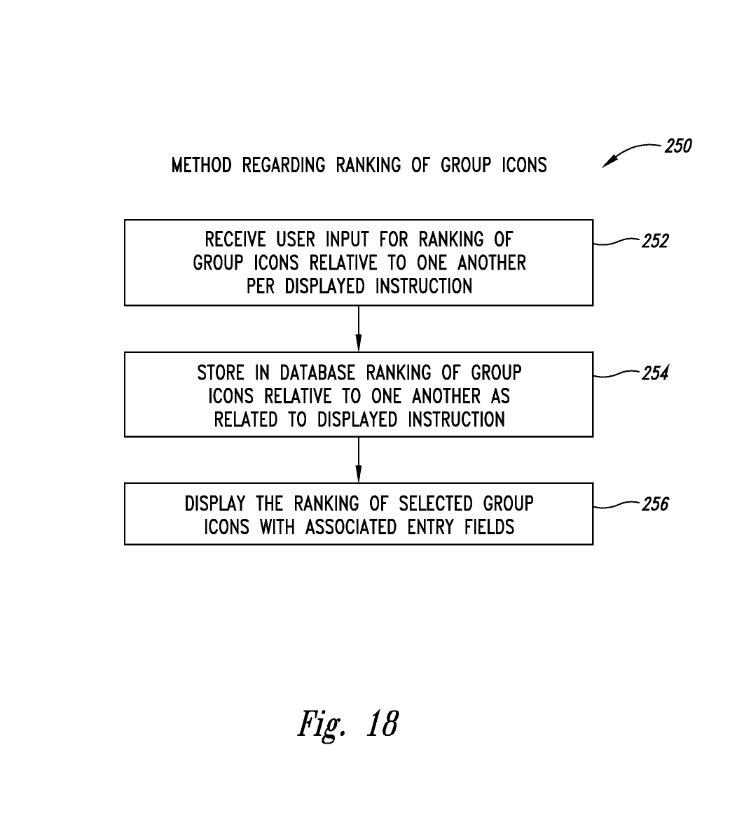

A method 250 regarding ranking of group icons is shown in FIG. 18 to include receiving (step 252) user input for ranking of selected cards relative to one another per an instruction displayed in the instruction area 140. Identification of the ranked group icons along with their ranking as related to the displayed instruction is stored (step 254) in the storage 114 for operation data of the database 106. The user interface 104 displays the ranked group icons along with their rankings as contained in associated entry fields 242 (step 256).

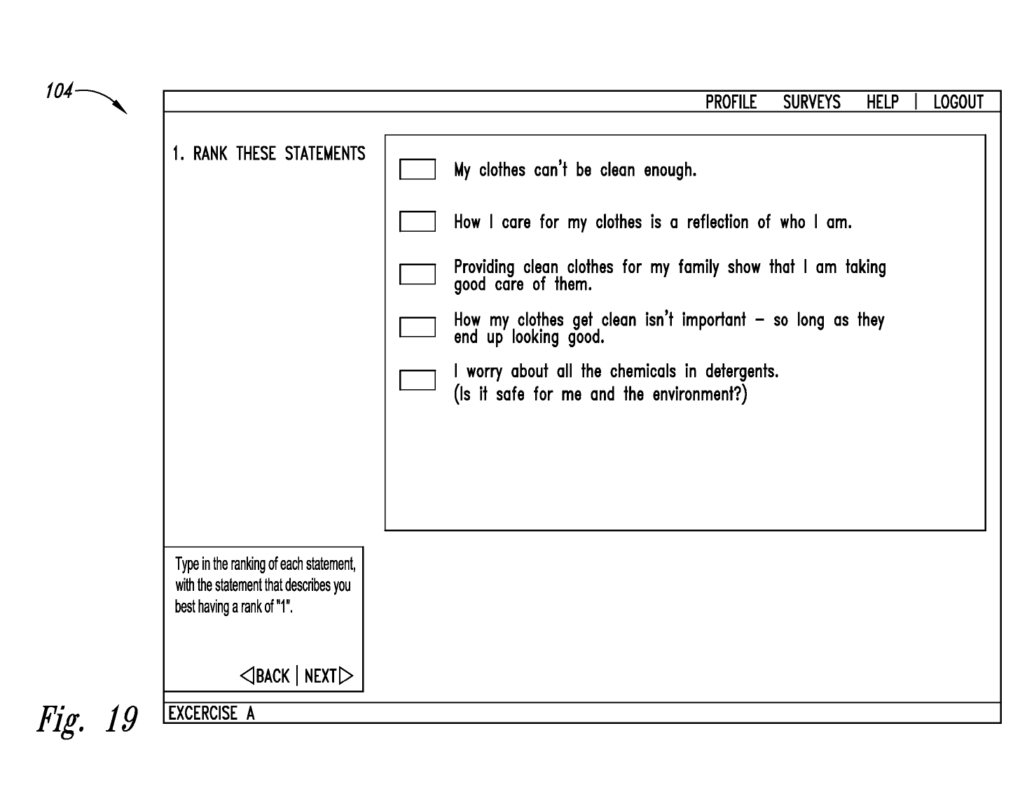

An exemplary implementation of the system is discussed regarding FIGS. 19-32. As shown in FIG. 19, a version of the user interface 104 is provided for users to begin a survey by ranking 5 statements. Additional questions can be provided that a user answers to determine perceptions, feelings and experiences around any given topic. This information is analyzed in the database to determine the user psychographics, which is stored in the storage 112. For example, if the user ranks the first statement as their top choice, the data collected in the entire survey can be analyzed based on users who select that statement versus selecting a different statement.

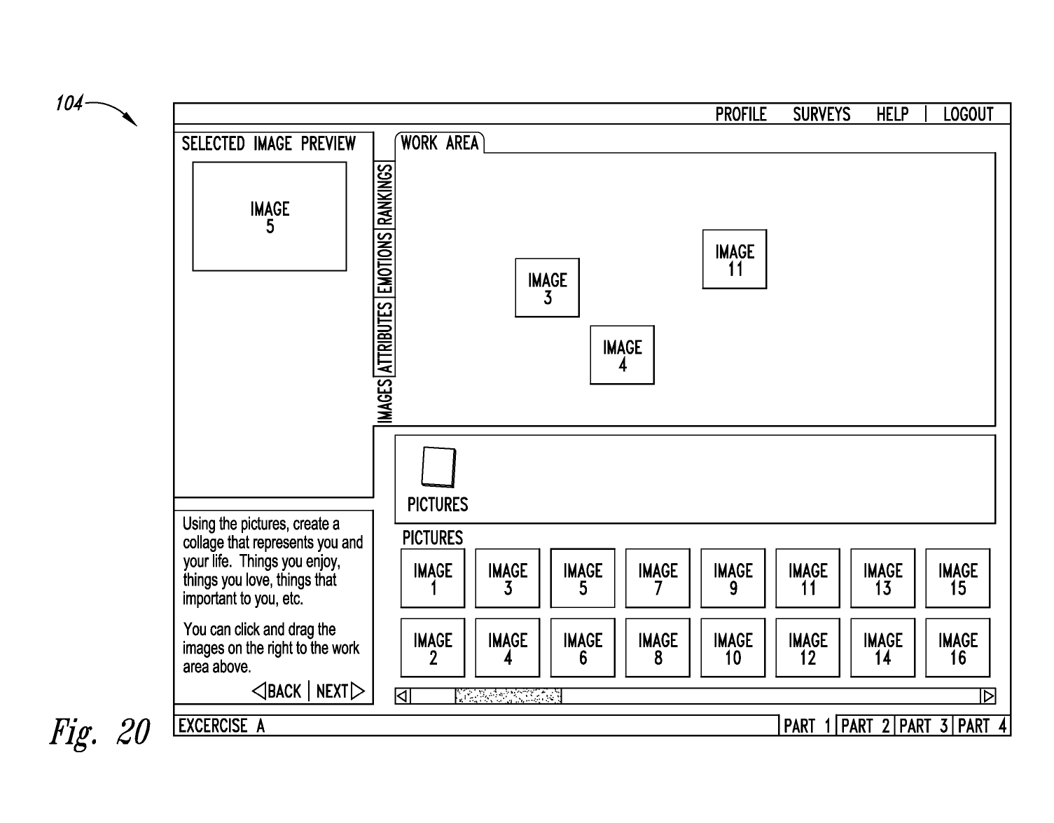

As shown in FIG. 20, a version of the user interface 104 is provided in which an instruction is displayed to request that users create a collage, which involves the users selecting cards 148 (image or text cards). As depicted, users select pictures based on displayed instructions. For instance, a sunset picture can be selected and can appear as a larger sized version in the properties area 138. For each of the cards 148, data can be stored in the storage 114 for operation data regarding how many times the card is selected by total user population or subsets of the user population based upon such factors as demographic or psychographic user profiles.

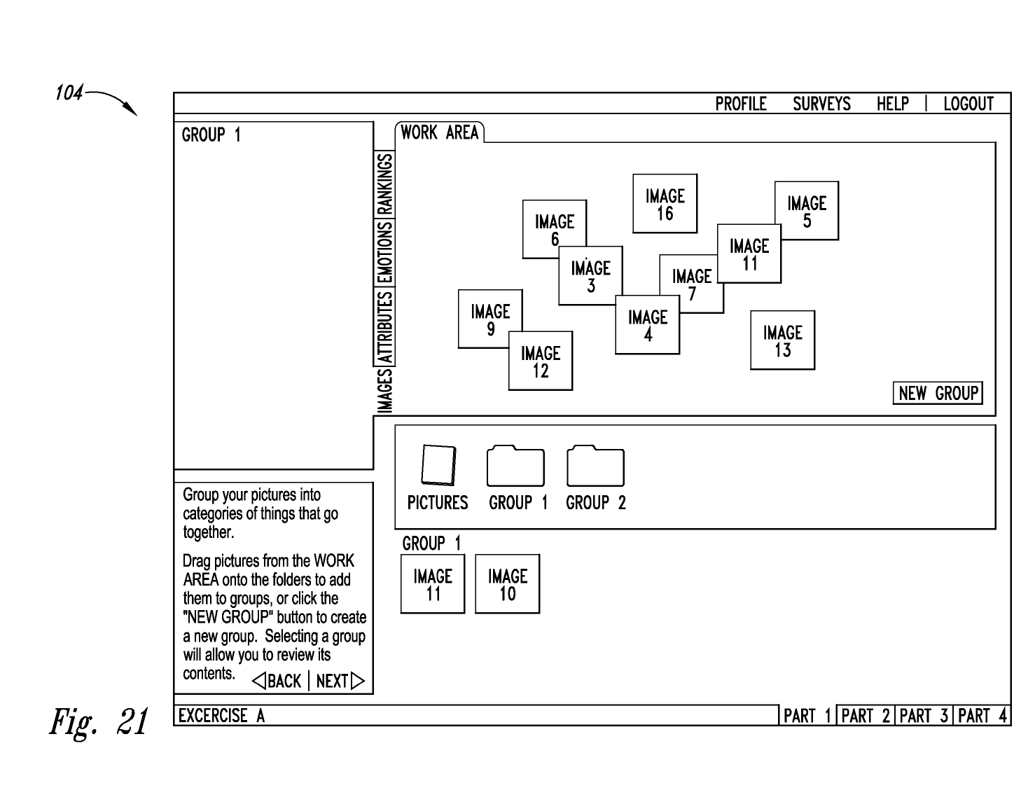

As shown in FIG. 21, a version of the user interface 104 displays an instruction for users to associate their selected pictures (cards) with group icons. The users drag the cards 148 to one or more of the group icons labeled as “Group 1” and “Group 2” as created by the user to create an association. For each of the cards 148, data can be stored in the storage 114 for operation data regarding how many times the card is associated with one of the group icons by total user population or subsets of the user population based upon such factors as demographic or psychographic user profiles.

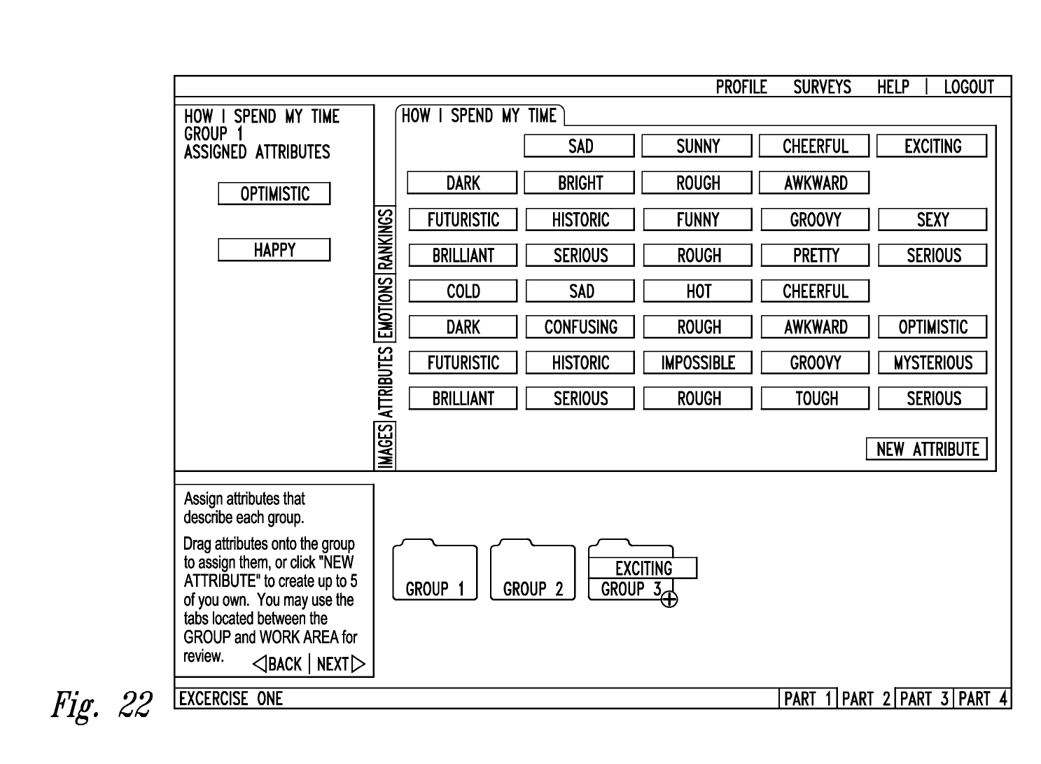

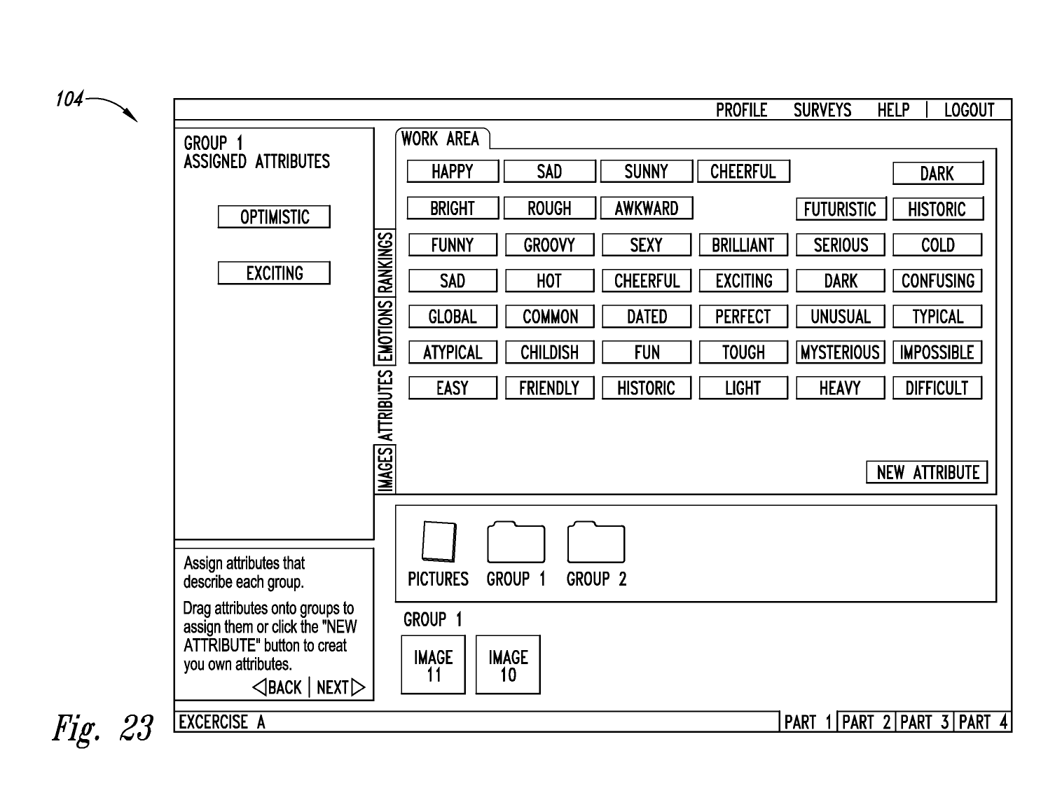

As shown in FIG. 22, a version of the user interface 104 displays an instruction to assign one or more text versions of the cards 148 to each of the group icons created to describe attributes of the group icon. Users use a drag and drop method to select and assign the cards 148 to each of the group icons. The selected cards describing attributes selected for each group icon also appear in the work area of the display. For each of the cards 148, data can be stored in the storage 114 for operation data regarding how many times the card is assigned to one of the group icons by total user population or subsets of the user population based upon such factors as demographic or psychographic user profiles.

As shown in FIG. 23, in this version of the user interface 104, when a user uses an input device to click on “Group 1” group icon, the pictures (cards) associated with the “Group 1” group icon appear in the work area.

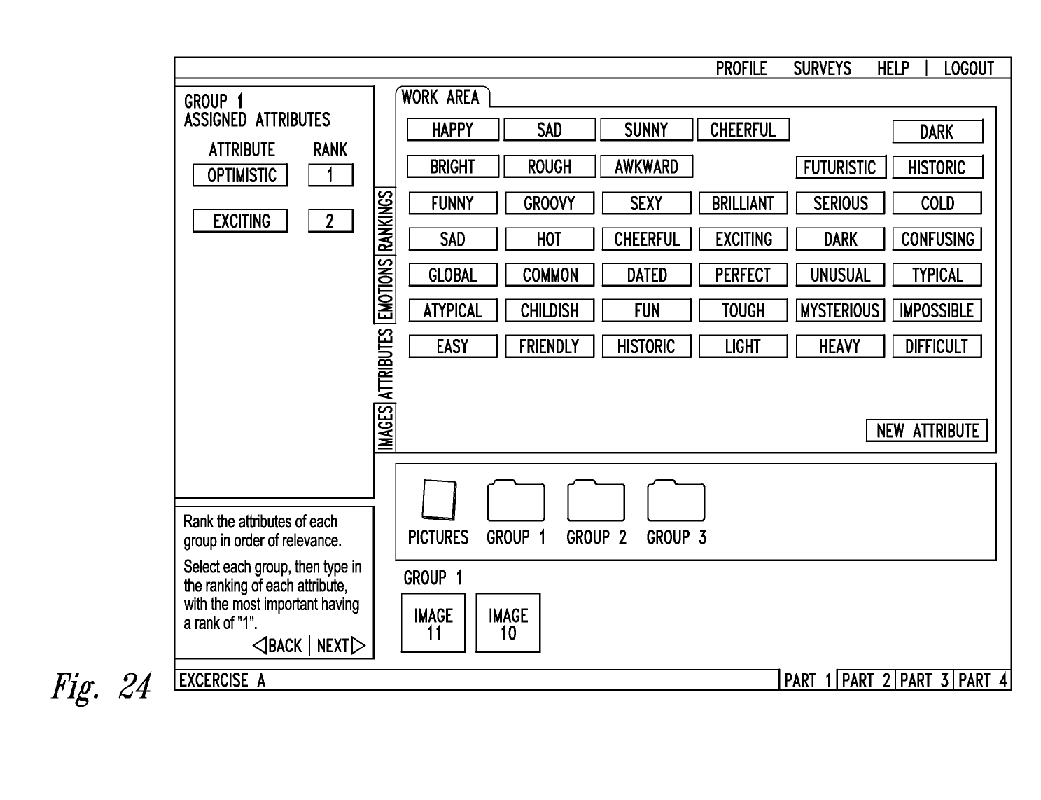

As shown in FIG. 24, this version of the user interface 104 displays an instruction for the users to rank the cards 148 having the selected attribute descriptions for each of the group icons according to their relevance to the group icon. Users can also select “New Attribute” button and create a card 148 describing an attribute of their creation. For each of the cards 148, data can be stored in the storage 114 for operation data regarding ranking of the card with respect to an assigned group icon by total user population or subsets of the user population based upon such factors as demographic or psychographic user profiles.

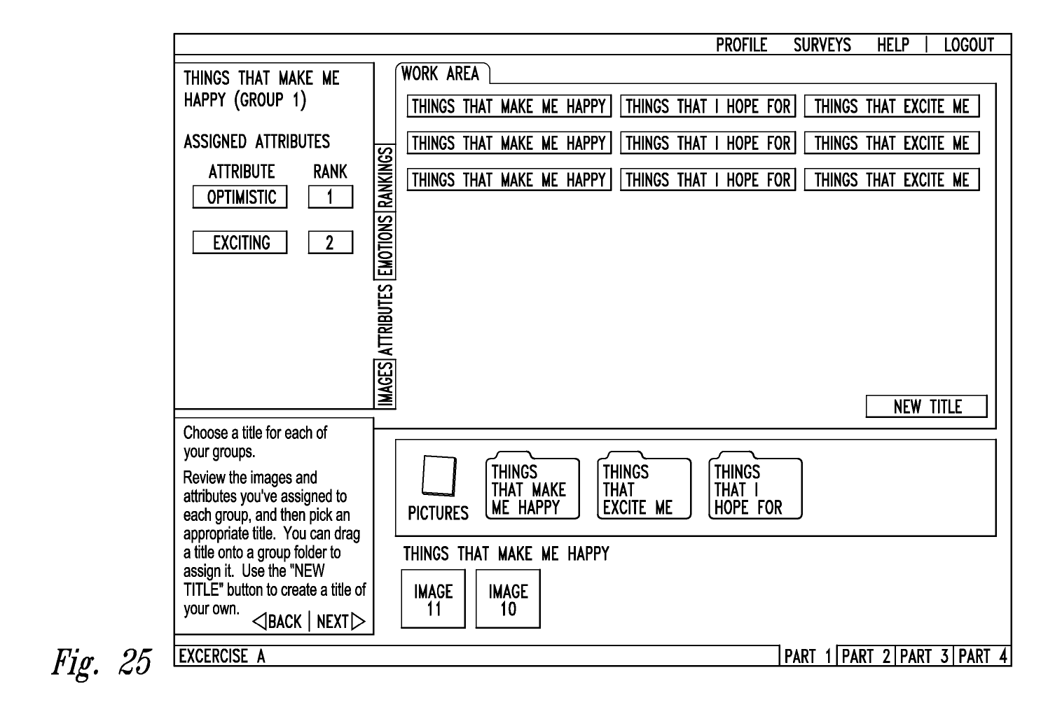

As shown in FIG. 25, this version of the user interface 104 displays an instruction for the users to assign to each of the group icons a card having text for a title and/or property for the group icon. For each of the cards 148, data can be stored in the storage 114 for operation data regarding the number of times that the card is selected and the number of times ranking of that the card is assigned to a group icon by total user population or subsets of the user population based upon such factors as demographic or psychographic user profiles.

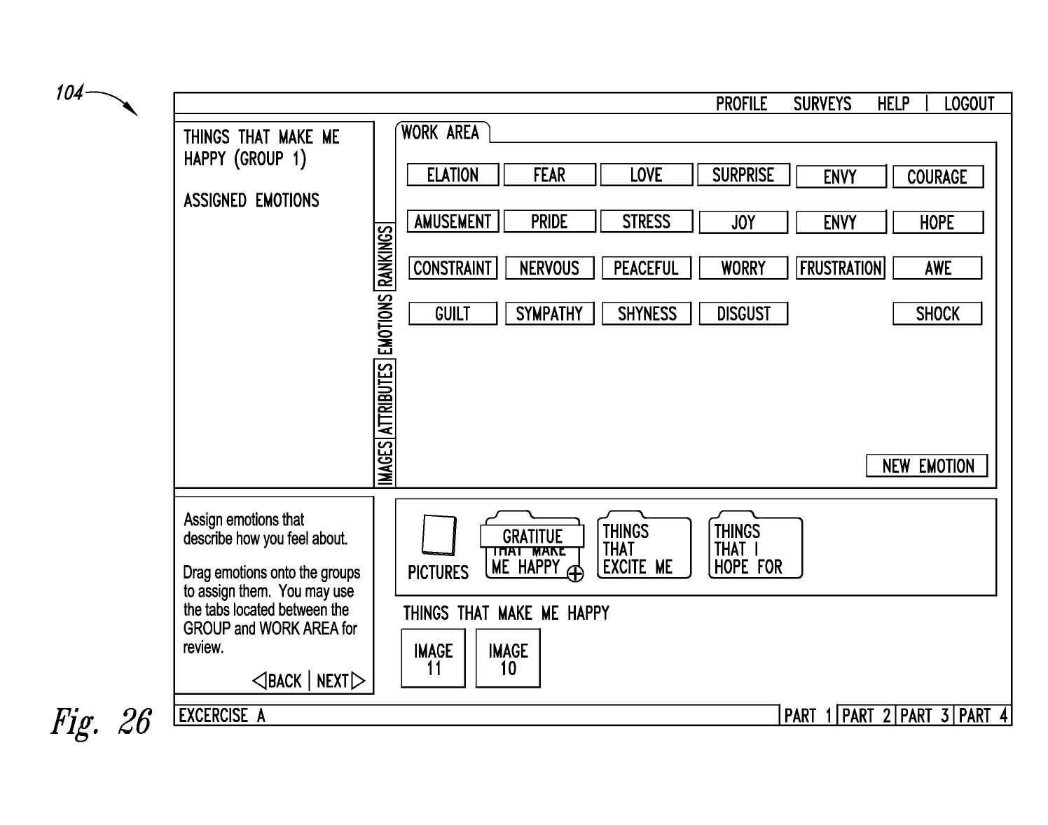

As shown in FIG. 26, this version of the user interface 104 displays an instruction for users to assign to each of the group icons one or more of the cards 148 that describe emotions. For each of the cards 148, data can be stored in the storage 114 for operation data regarding the number of times that the card is selected and the number of times ranking of that the card is assigned to a group icon by total user population or subsets of the user population based upon such factors as demographic or psychographic user profiles.

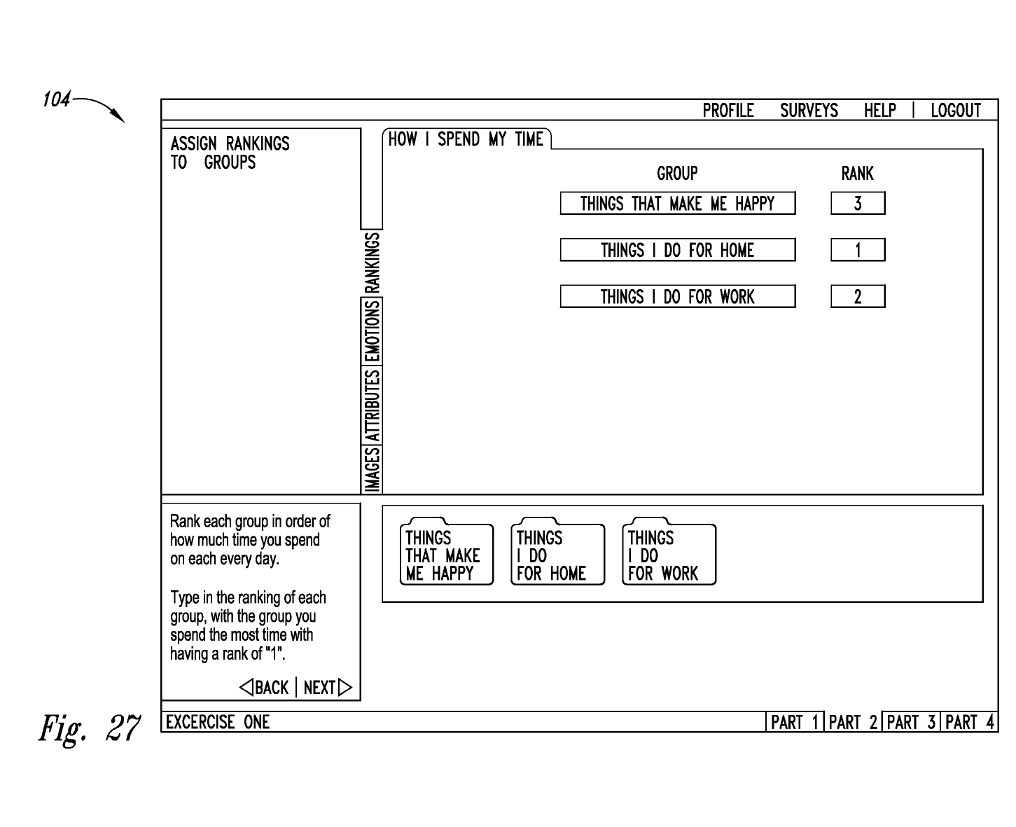

As shown in FIG. 27, this version of the user interface 104 displays an instruction for users to rank group icons based on a specific direction such as based on “how much time you spend on each every day”. For each of the group icons, data can be stored in the storage 114 for operation data regarding the number of times that the group icon received a particular ranking by total user population or subsets of the user population based upon such factors as demographic or psychographic user profiles.

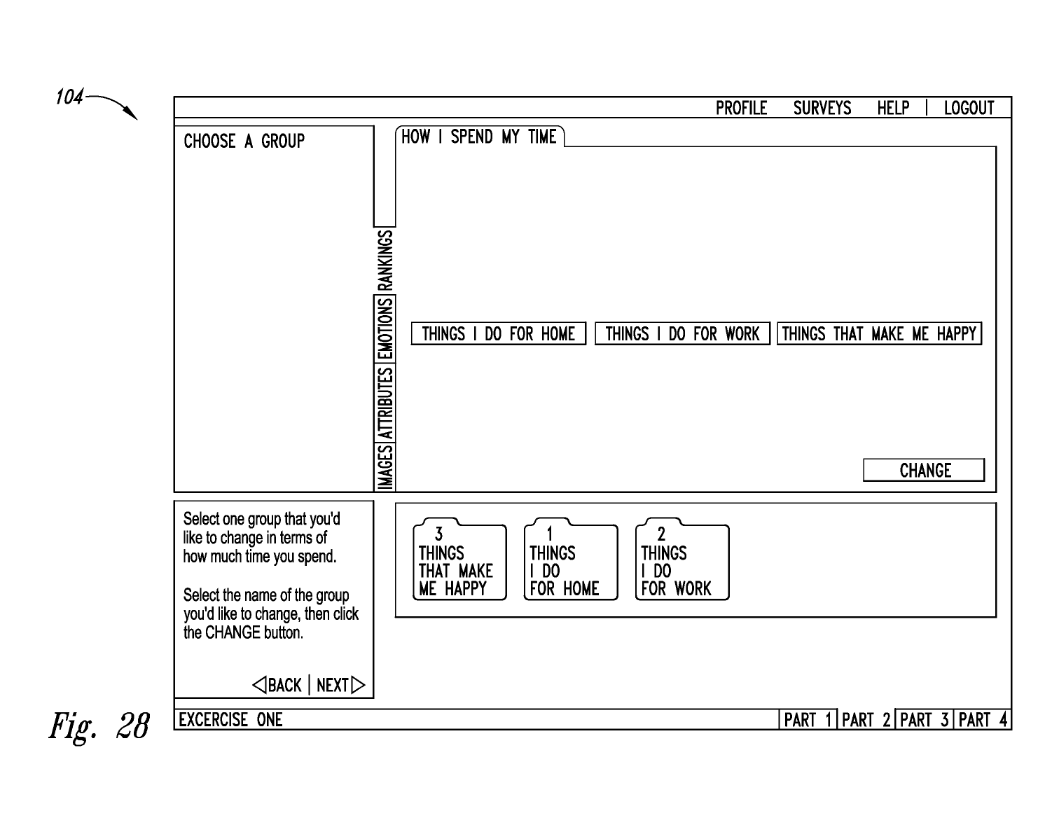

As shown in FIG. 28, this version of the user interface 104 displays an instruction for a user to select one of the group icons that the user would like to change, based on a specific direction such as the group icon that they would “like to change in terms of how much time you spend”. For each of the group icons, data can be stored in the storage 114 for operation data regarding the number of times that the group icon was selected by total user population or subsets of the user population based upon such factors as demographic or psychographic user profiles.

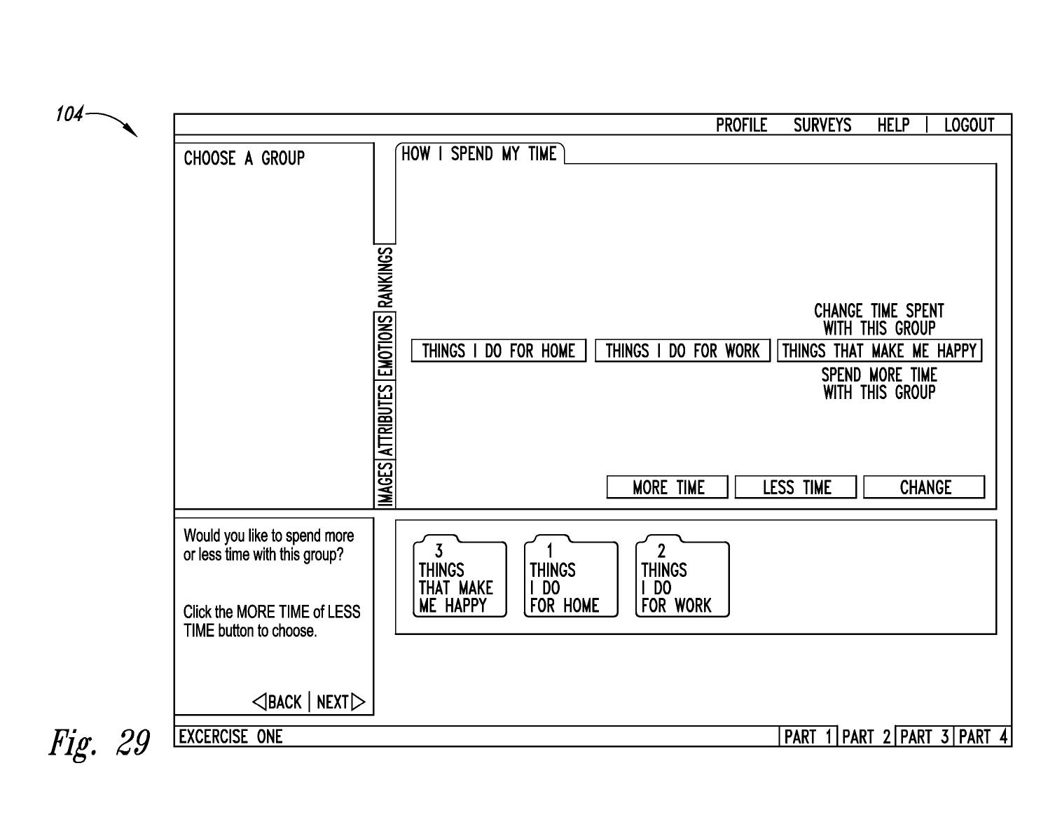

As shown in FIG. 29, this version of the user interface 104 displays an instruction for a user to select one of the cards 148 describing how they would like to change how they spend their time as associated with a group icon. For each of the group icons, data can be stored in the storage 114 for operation data regarding the number of times that the card 148 was selected by total user population or subsets of the user population based upon such factors as demographic or psychographic user profiles.

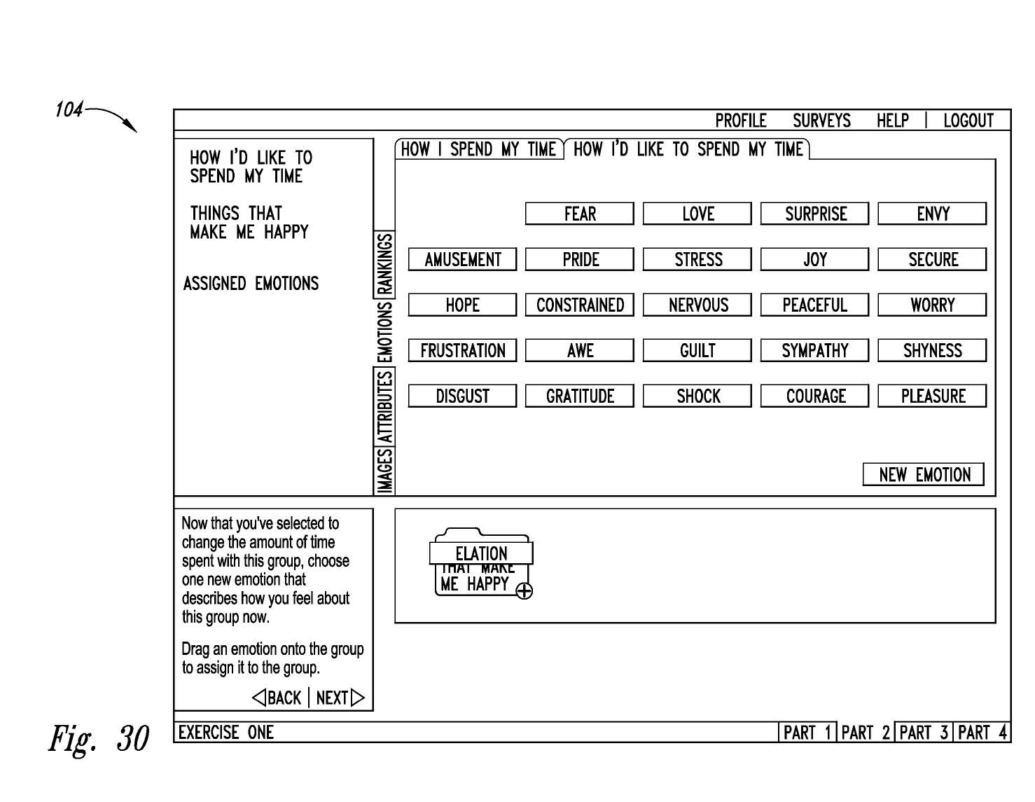

As shown in FIG. 30, this version of the user interface 104 displays an instruction for a user to select one of the cards 148 that describes an emotion that “describes how you feel about this group now” based on the indicated change in time spent. For each of the group icons, data can be stored in the storage 114 for operation data regarding the number of times that the card 148 was selected and assigned to one of the group icons, as well as comparing the number of times one of the cards 148 describing a particular emotion is selected by total user population or subsets of the user population based upon such factors as demographic or psychographic user profiles.

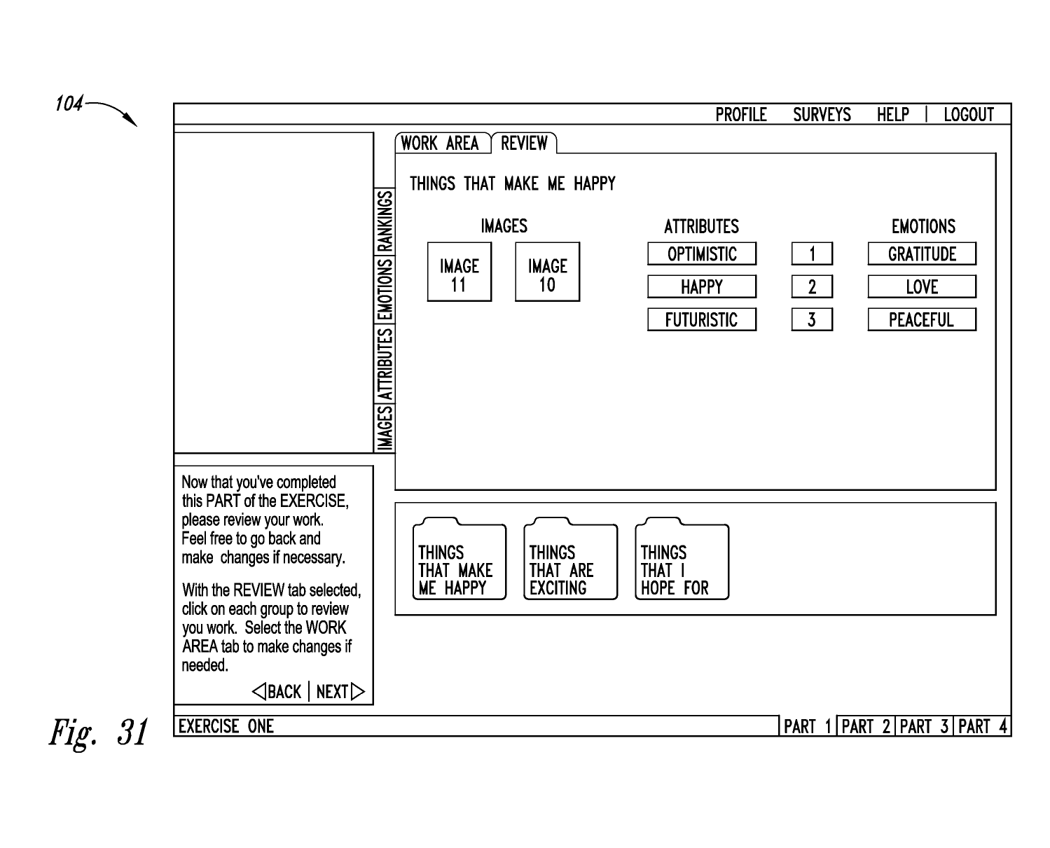

As shown in FIG. 31, this version of the user interface 104 allows a user to review each group icon and the cards and/or objects associated with the group icon, the cards assigned to the group object, and the related rankings.

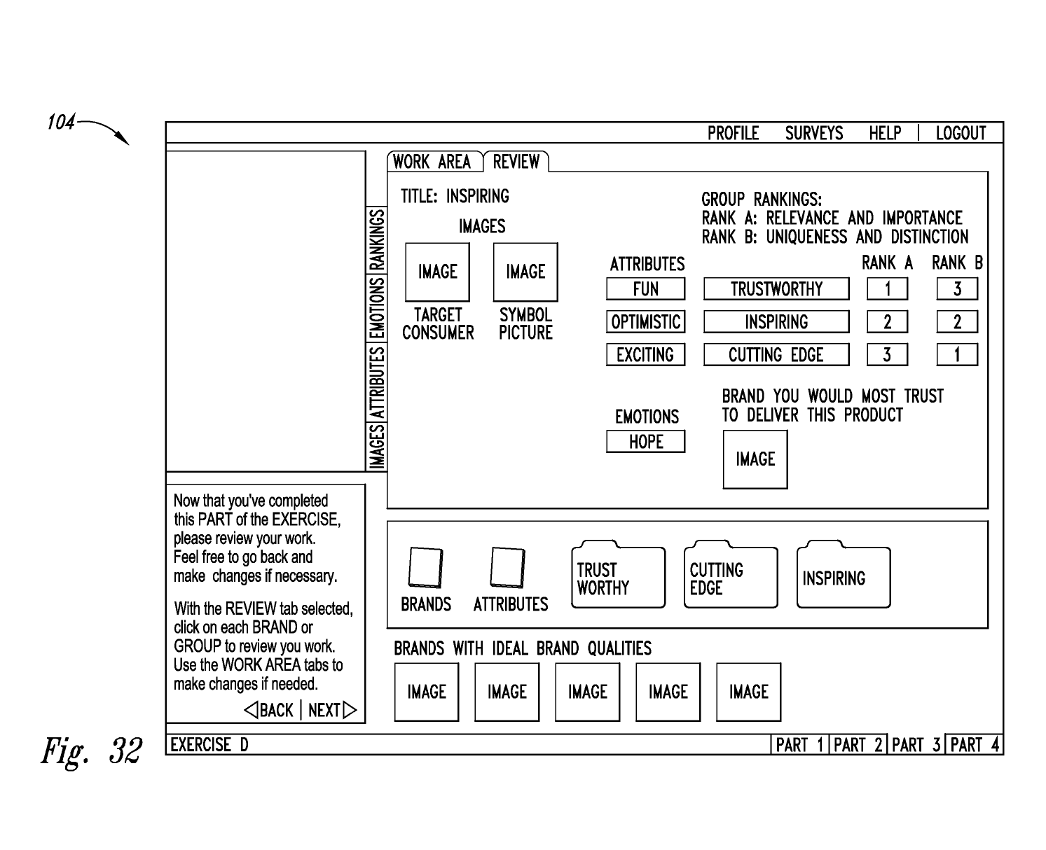

As shown in FIG. 32, this version of the user interface 104 displays a review of what the user has done in each operation. At this point, the user has the option to return to a previously completed screen and make changes to the user's input.

As stated, data is stored in the storage 114 for operation data for further analysis. Examples of analysis include the following using the term “frequency,” which is the exemplary cases means the number of, incident rate, and occurrence.

An analysis could involve frequency of cards selected such as the number of times image A (card) is selected for a particular exercise having a certain instruction display and the number of times attribute “fun” is selected. As an example, the analysis from the analysis engine 116 could be as follows: image A was selected in the collage exercise 50% of the time by women 25-50)

Another example of analysis could be frequency of objects (cards and/or group icons) piled or grouped (associated with another group icon). The example could include the number of times Image B (card) is associated with a group icon or card representing Brand X. Another example could include the number of times an image (card) of a tree is associated with a group icon that is also associated with an image (card) of a saw or otherwise associated (piled) together. Another example could include the number of times a brand card such as “Nike” is associated with card (attribute card “creative”) either through direct assignment of the attribute card to the brand card or through a mutual association with a group icon. The analysis engine 116 could output the following: 35% of men ages 50-65 associate Nike with creative versus 65% of women ages 50-65 associate Nike with creative. Another output could be the image of a foot is associated with Nike 75% of the time for women.

Another example of analysis could be objects (cards and/or group icons) ranked (number of times an object is ranked in a particular order for an instruction of an exercise or the number of times Family, Work and Money is ranked in the top 3 for “what is most important to you” OR the number of times Family is ranked first versus Work. The analysis engine 116 could output the following: Family was ranked in the top three choices 86% of the time for teens 15-18 for ‘what is most important to you’ OR 15% of women 25-45 picked Family as their top choice for “what is most important to you” versus 45% put Family in their top 3 choices)

Another example of analysis could be objects (cards and/or group icons) assigned to other objects (number of times image A (card) is assigned to Brand Card B (card); number of times attribute “fun” (card) is assigned to a picture of a Family (card) OR number of times the word “monopoly” (card) is assigned to Microsoft (group icon or card). In the analysis engine 116, the output could be, Microsoft is thought of as a monopoly by 85% of men 18-55, or Family equates to fun 15% of the time for new moms versus 85% of the time for newlywed couples.

Another example of analysis could be frequency of objects (cards and/or group icons) selected, piled (associated with other group icons directly or through prior associated group icons), grouped, ranked, or assigned to other objects as compared to the frequency of a second or multiple other objects selected, piled, grouped, ranked or assigned to second objects such as the number of times “fun” is assigned to a picture of Family versus the number of times “loving” is assigned to that same picture. In the database, the output could be, Family is associated with the idea of “loving” 90% of the time for women 24-55 versus “fun” is only 45% of the time.

Other analysis could include comparisons such as compare Nike (card or group icon) and Adidas (card or group icon) by selecting an image (card) that represents how you feel about Nike (card or group icon) and one that represents how you feel about Adidas (card or group icon). In the database server 106, the frequency of images (card) assigned to or associated with Nike (card or group icon) or Adidas (card or group icon) is gathered and compared. As an example 55% of users selected one of three images (card) to associate with Nike (card or group icon) versus only 5% selected one of the three images to be associated with Adidas (card or group icon).

Another example of comparison would be to compare ad 1 and ad 2 by assigning attributes (cards) to each ad that represent the key message of each, and/or selecting the image (card) image that best represents how the user feels feel about each ad. In the database server 106, the frequency of the attributes (cards) and images (cards) selected will be compared. For example: 45% of users selected “disposable” and “colorful” to represent ad 1 versus “plain” and “wasteful” for ad 2 OR 15% of users assigned the image of a crying baby to ad 1 versus 69% assigned that image to ad 2.

In one or more various implementations, related systems include but are not limited to circuitry and/or programming for effecting the foregoing-referenced method implementations; the circuitry and/or programming can be virtually any combination of hardware, software, and/or firmware configured to effect the foregoing-referenced method implementations depending upon the design choices of the system designer.

The descriptions are summaries and thus contain, by necessity; simplifications, generalizations and omissions of detail; consequently, those skilled in the art will appreciate that the summaries are illustrative only and are not intended to be in any way limiting. Other aspects, inventive features, and advantages of the devices and/or processes described herein, as defined solely by the claims, will become apparent with respect to the non-limiting detailed description set forth herein.

Those having ordinary skill in the art will also appreciate that although only a number of server applications are shown, any number of server applications running on one or more server computer could be present (e.g., redundant and/or distributed systems could be maintained). Lastly, those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. A system comprising:
a database; and
a device having a user interface and a user input to receive input from a user, the device communicatively linked to the database, the user interface having a first portion to display an instruction, the user interface configured to display the card as being one of selected and unselected, the device configured to send data to the database identifying the instruction and the card as selected upon the card being selected.

2. The system of claim 1 wherein the user interface includes a second portion to display a card before the card is identified as being selected, and a third portion to display the card as being selected, the device configured to send data to the database identifying the instruction and the card as selected upon the card being displayed in the third portion.

3. The system of claim 1 wherein the device is configured to send data identifying a characteristic of the user based upon a portion of the input received by the user.

4. The system of claim 1 wherein the user interface is configured to display the card as an image.

5. The system of claim 1 wherein the user interface is configured to display the card as text.

6. A method comprising:
receiving user input from a user interface to demarcate a card being displayed by the user interface as selected by a user in response to an instruction displayed in a portion of the user interface; and
storing in a database identification of the card as being selected as related to the instruction.

7. The method of claim 6 including displaying the card with the user interface as being selected.

8. The method of claim 6 wherein the receiving includes receiving data identifying a characteristic of the user based upon a portion of the input received by the user.

9. A computer program storage medium readable by a computing system and configured to encode a computer program for executing a computer process, the computer process comprising:
receiving user input from a user interface to demarcate a card being displayed by the user interface as selected by a user in response to an instruction displayed in a portion of the user interface; and
storing in a database identification of the card as being selected as related to the instruction.

10. The computer process of claim 9 including displaying the card with the user interface as being selected.

11. The computer process of claim 9 wherein the receiving includes receiving data identifying a characteristic of the user based upon a portion of the input received by the user.
